(19) United States
(12) Patent Application Publication
(10) Pub. No.: US 2026/0323684 A1
(43) Pub. Date: Oct. 15, 2026

(54) Mechanisms to Protect Long Range Transmissions in WiFi System

(71) Applicant: InterDigital Patent Holdings, Inc., Wilmington, DE (US)

(72) Inventors: Hanqing LOU, Syosset, NY (US); Xiaofei WANG, North Caldwell, NJ (US); Ying WANG, Easton, PA (US); Mahmoud SAAD, L’Ile Bizard (CA); Rui YANG, Greenlawn, NY (US)

(21) Appl. No.: 19/177,131

(22) Filed: Apr. 11, 2025

(51) Int. Cl. H04W 74/00; H04W 28/02; H04W 74/0816

(52) U.S. Cl. CPC H04W 74/002; H04W 28/0278; H04W 74/0816

(57) ABSTRACT

Apparatuses, architectures, and methods directed to protecting long range transmission in wireless networks are described. A first station (STA) transmits a first PPDU including a first frame to a second STA. The first PPDU is defined for use with a first transmission range. The first STA transmits a second PPDU including a second frame to the second STA. The second PPDU is defined for use with a second transmission range. The first frame or the second frame includes, respectively, first and second information for soliciting a response from the second STA. The first STA receives at least a third PPDU including a third frame from the second STA, and the third PPDU is defined for use with the first transmission range. The first STA transmits data to the second STA based on the third PPDU including third information in the third frame indicating availability to receive data.

### TECHNICAL FIELD

Example embodiments described in the present disclosure are generally directed to the fields of communications, software and encoding, including methods, architectures, apparatuses, and systems directed to mechanisms to protect long range transmission in wireless networks.

### BACKGROUND

A wireless local area network (WLAN) in infrastructure basic service set (BSS) mode has an access point (AP) for the BSS and one or more stations (STAs) associated with the AP. Interference in a WLAN can occur when a STA fails to hear an ongoing transmission in a channel and transmits to other STAs via the AP (e.g., hidden node problem). Embodiments described herein have been designed with the foregoing in mind.

### SUMMARY

An apparatus, architecture, and method directed to mechanisms to protect long range transmission in wireless networks are described. In an embodiment, a first station (STA) may include circuitry including a transmitter, a receiver, a processor, and memory. The first STA may be configured to transmit a first physical layer protocol data unit (PPDU) to a second STA, wherein the first PPDU is defined for use with a first transmission range and the first PPDU may be a first frame. The first STA may be configured to transmit a second PPDU to the second STA, wherein the second PPDU is defined for use with a second transmission range and the second transmission range extends beyond the first transmission range. The second PPDU may be a second frame and at least one of the first frame or the second frame may be, respectively, first and second information for soliciting a response from the second STA. The first STA may be configured to receive a third PPDU from the second STA, wherein the third PPDU is defined for use with the first transmission range and may be a third frame; and the first STA may be configured to transmit data to the second STA based on the third PPDU comprising third information in the third frame indicating availability to receive data.

In an embodiment, the first STA may be configured to transmit the first PPDU to the second STA, wherein the first PPDU is defined for use with the first transmission range and the first PPDU may be the first frame; and the first STA may be configured to transmit the second PPDU to the second STA, wherein the second PPDU is defined for use with the second transmission range and the second transmission range extends beyond the first transmission range. The second PPDU may be the second frame and at least one of the first frame or the second frame may be, respectively, the first and second information for soliciting a response from the second STA. The first STA may be configured to receive a third PPDU from the second STA, wherein the third PPDU is defined for use with the first transmission range and may be the third frame. The first STA may be configured to receive a fourth PPDU from the second STA, wherein the fourth PPDU is defined for use with the second transmission range, and the fourth PPDU may be a fourth frame. The first STA may be configured to transmit the data to the second STA based on the third and fourth PPDUs, wherein either the third information in the third frame or fourth information in the fourth frame indicates availability to receive data.

In an embodiment the STA may be configured to transmit the first PPDU to the second STA, wherein the first PPDU is defined for use with a first transmission range, and the first PPDU may be a first frame. The first STA may be configured to transmit the second PPDU to the second STA, wherein the second PPDU is defined for use with the second transmission range. The second transmission range extends beyond the first transmission range, and the second PPDU may be a second frame, and at least one of the first frame or the second frame may comprise, respectively, first and second information to solicit a second response from the second STA. The first STA may be configured to prevent (e.g., forego, refrain from, or not perform) transmission of data to the second STA based on a failure to receive a third PPDU from the second STA in response to the first PPDU, or failure to receive a fourth PTO from the second STA in response to the second PPDU.

An embodiment may include a method, which may be performed or implemented by a STA. The method may include transmitting a first PPDU to a second STA, wherein the first PPDU is defined for use with a first transmission range and the first PPDU may be a first frame. The method may include transmitting a second PPDU to the second STA, wherein the second PPDU is defined for use with a second transmission range and the second transmission range extends beyond the first transmission range. The second PPDU may be a second frame and at least one of the first frame or the second frame may be, respectively, first and second information for soliciting a response from the second STA. The method may include receiving a third PPDU from the second STA, wherein the third PPDU is defined for use with the first transmission range and may be a third frame; and transmitting data to the second STA based on the third PPDU comprising third information in the third frame indicating availability to receive data.

An embodiment may include a method, which may be performed or implemented by the STA. The method may include transmitting the first PPDU to the second STA, wherein the first PPDU is defined for use with the first transmission range and the first PPDU may be the first frame. The method may include transmitting the second PPDU to the second STA, wherein the second PPDU is defined for use with the second transmission range and the second transmission range extends beyond the first transmission range. The second PPDU may be the second frame and at least one of the first frame or the second frame may be, respectively, the first and second information for soliciting a response from the second STA. The method may include receiving a third PPDU from the second STA, wherein the third PPDU is defined for use with the first transmission range and may be the third frame. The method may include receiving a fourth PPDU from the second STA, wherein the fourth PPDU is defined for use with the second transmission range, and the fourth PPDU may be a fourth frame. The method may include transmitting the data to the second STA based on the third and fourth PPDUs, wherein either the third information in the third frame or fourth information in the fourth frame indicates availability to receive data.

An embodiment may include a method, which may be performed or implemented by the STA. The method may include transmitting the first PPDU to the second STA, wherein the first PPDU is defined for use with a first transmission range, and the first PPDU may be a first frame. The method may include transmitting the second PPDU to the second STA, wherein the second PPDU is defined for use with the second transmission range. The second transmission range extends beyond the first transmission range, and the second PPDU may be a second frame, and at least one of the first frame or the second frame may comprise, respectively, first and second information to solicit a second response from the second STA. The method may include preventing (e.g., forego, refrain from, or not perform) transmission of data to the second STA based on a failure to receive a third PPDU from the second STA in response to the first PPDU, or failure to receive a fourth PTO from the second STA in response to the second PPDU.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals ("ref.") in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIGS. 2A-3 are diagrams illustrating examples of existing problems regarding long range transmission protection in a wireless network;

FIG. 4 is a diagram illustrating an example frame structure of a first physical layer protocol data unit (PPDU) PPDU according to an embodiment;

FIG. 5 is a diagram illustrating an example process of dual transmission for providing long range transmission protection in a wireless network according to an embodiment;

FIG. 6 is a diagram illustrating another example of dual transmission for providing long range transmission protection in a wireless network according to an embodiment;

FIG. 7 is a flow diagram illustrating an example method of dual transmission for providing long range transmission protection in a wireless network according to an embodiment;

FIG. 8 is a flow diagram illustrating another example method of dual transmission for providing long range transmission protection in a wireless network in accordance with an embodiment; and

FIG. 9 is a flow diagram illustrating an example method of preventing (e.g., forego, refrain from, or not perform) dual transmission according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively "provided") herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

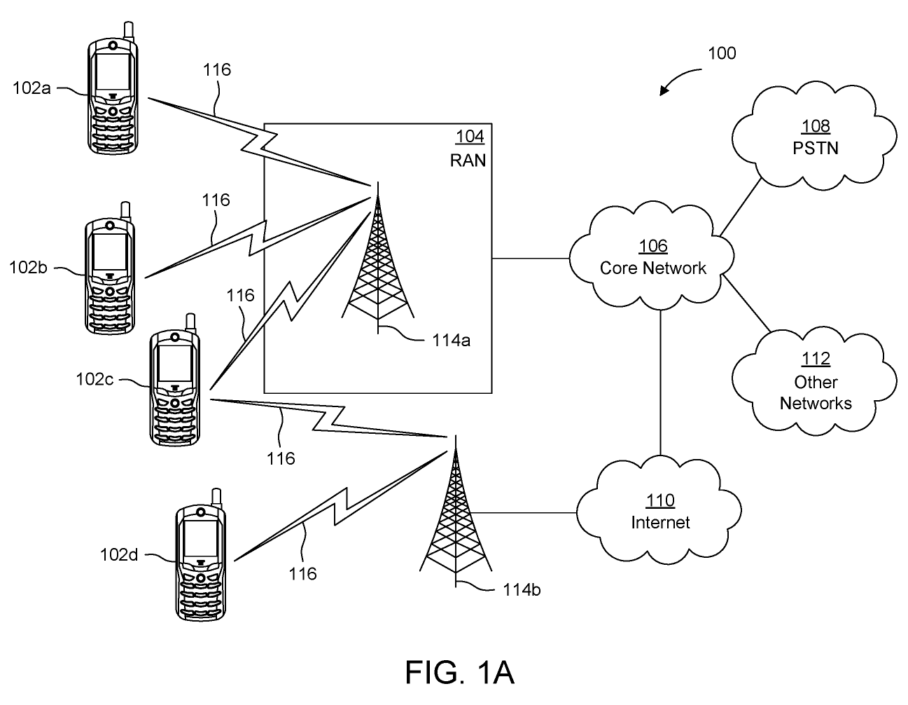

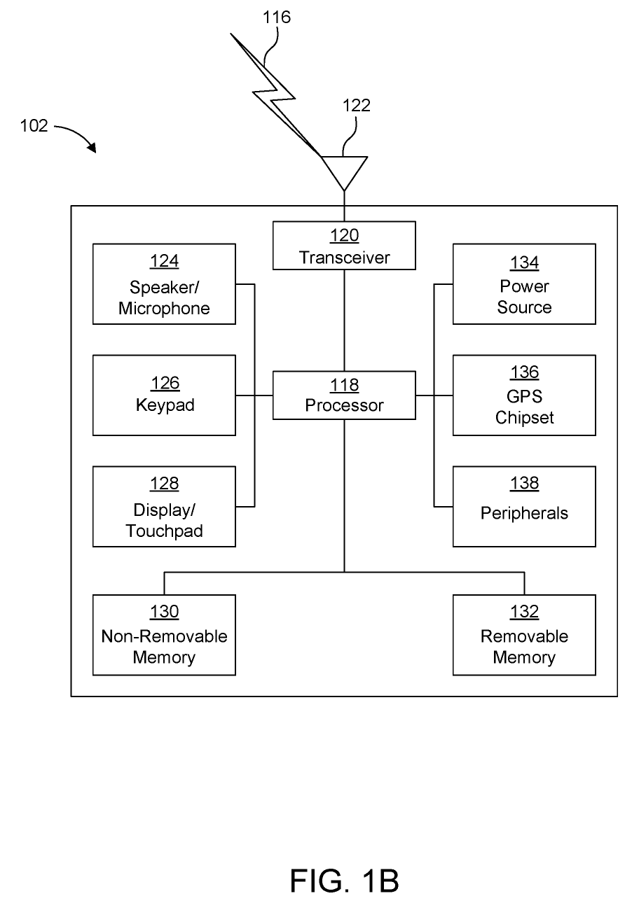

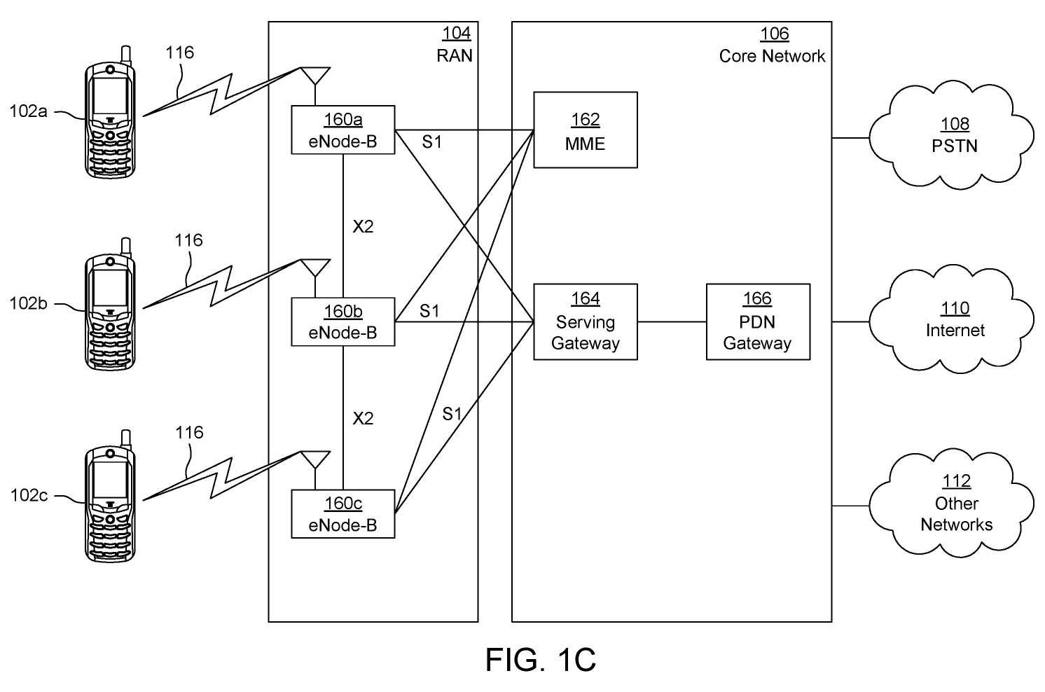

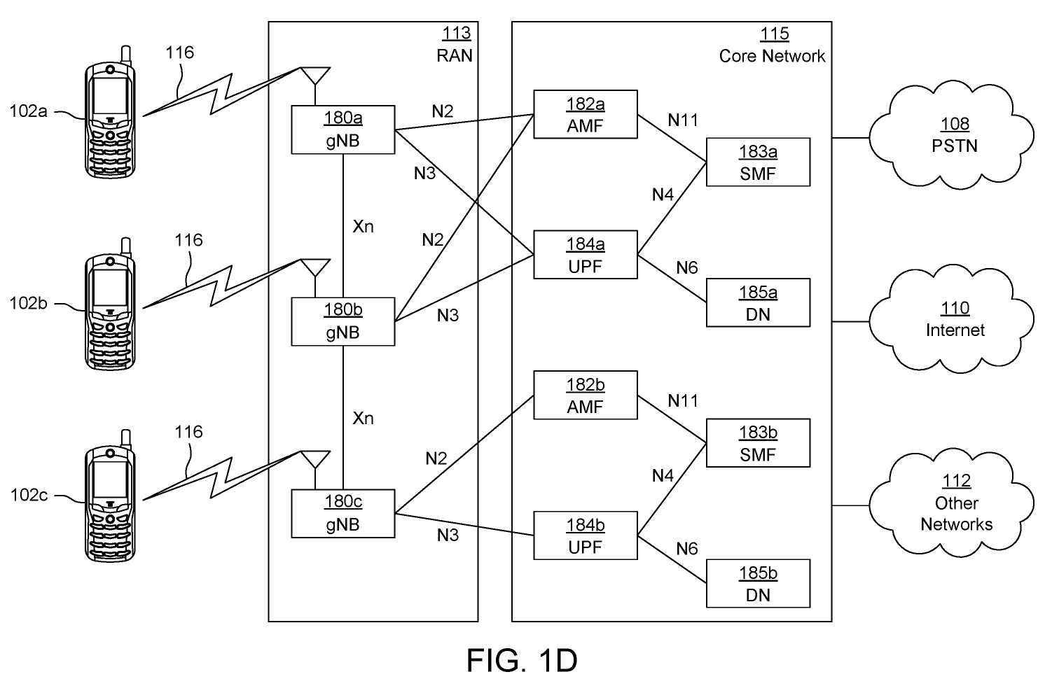

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102cand 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

The RAN 113 may include gNBs 180a, 180b, 180c, though it will be appreciated that the RAN 113 may include any number of gNBs while remaining consistent with an embodiment. The gNBs 180a, 180b, 180cmay each include one or more transceivers for communicating with the WTRUs 102a, 102b, 102c over the air interface 116. In one embodiment, the gNBs 180a, 180b, 180cmay implement MIMO technology. For example, the gNBs 180a, 180b, 180cmay utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180cmay implement carrier aggregation technology. For example, the gNB 180amay transmit multiple component carriers to the WTRU 102a (not shown). A subset of these component carriers may be on unlicensed spectrum while the remaining component carriers may be on licensed spectrum. In an embodiment, the gNBs 180a, 180b, 180cmay implement Coordinated Multi-Point (CoMP) technology. For example, WTRU 102amay receive coordinated transmissions from gNB 180aand gNB 180b(and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180cusing subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102cin a standalone configuration and/or a non-standalone configuration. In the standalone configuration, WTRUs 102a, 102b, 102c may communicate with gNBs 180a, 180b, 180cwithout also accessing other RANs (e.g., such as eNode-Bs 160a, 160b, 160c). In the standalone configuration, WTRUs 102a, 102b, 102c may utilize one or more of gNBs 180a, 180b, 180cas a mobility anchor point. In the standalone configuration, WTRUs 102a, 102b, 102c may communicate with gNBs 180a, 180b, 180cusing signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102cmay implement DC principles to communicate with one or more gNBs 180a, 180b, 180c and one or more eNode-Bs 160a, 160b, 160csubstantially simultaneously. In the non-standalone configuration, eNode-Bs 160a, 160b, 160cmay serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183bmay also be connected to a UPF 184a, 184b in the CN 115 via an N4 interface. The SMF 183a, 183bmay select and control the UPF 184a, 184band configure the routing of traffic through the UPF 184a, 184b. The SMF 183a, 183bmay perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102cmay be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time, and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20MHz, 40 MHz, 80 MHz, and/or 160 MHz wide channels transmitted over a 5GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20MHz, 40 MHz, 80 MHz, and/or 160 MHz wide channels capable of transmission over 2.4GHz, 5GHz, and 6GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability - UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding Wi-Fi communications into the millimeter-wave frequency band (integrated millimeter-wave - IMMW), energy harvesting based on of Wi-Fi RF signals for facilitating WLAN communications of low-power IoT devices, and the randomization of MAC addresses in WLANs.

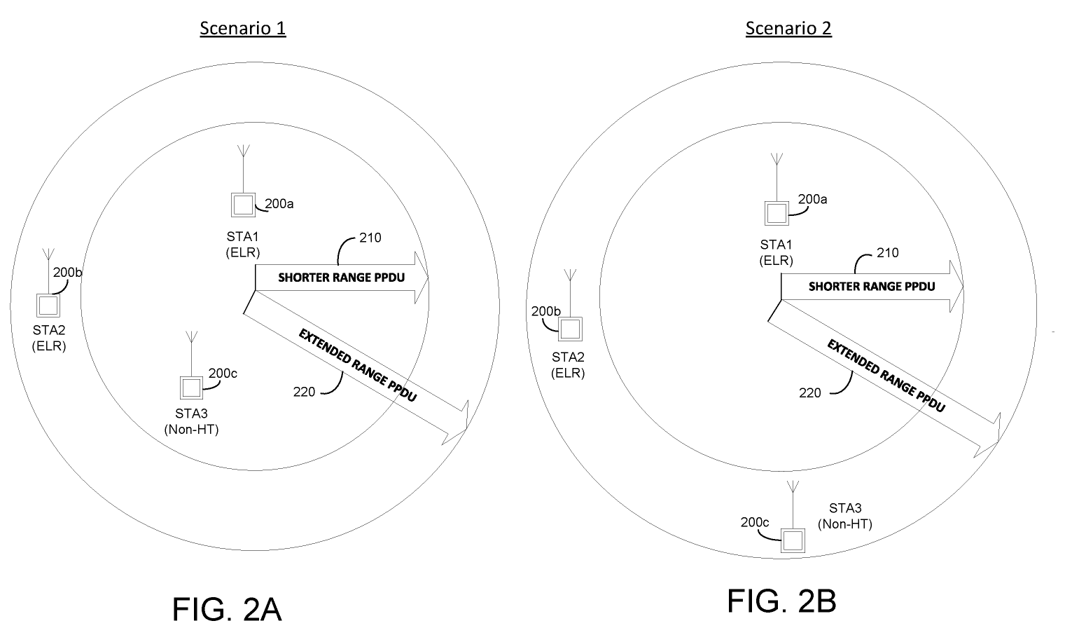

FIGS. 2A and 2B are block diagrams illustrating examples of potential problems regarding long range transmission protection in a wireless network. FIG. 2A is an example that illustrates a “scenario 1” and shows STA1 200a, STA2 200b, and STA3 200c in a wireless network. In FIG. 2A, STA3 200c is a non-high throughput (non-HT) STA (e.g., legacy STA) positioned within a coverage area in which STA3 200c is in a transmission range of STA1 200a based on being able to receive and/or transmit a physical layer protocol data unit (PPDU) 210 (e.g., a non-HT PPDU) to or from STA1 200a. STA1 200a is capable of transmission and reception of both non-HT PPDUs and enhanced long range (ELR) PPDUs (i.e., beyond the range of STA3 200c). STA1 200a may be referred to as an ELR STA in view of (at least) having the capability of transmitting and receiving ELR PPDUs.

FIG. 2B is an example that illustrates a “scenario 2” and shows STA1 200a, STA2 200b, and STA3 200c in a wireless network. However, the scenario in FIG. 2B is different from the scenario in FIG. 2B in that STA3 200c and STA2 200b are both positioned within the extended range PPDU 220 or ELR PPDU transmission range of STA1. STA3 200c is a non-HT STA (e.g., legacy STA), and both STA1 200a and STA2 200b are ELR STAs capable of transmission of non-HT PPDUs and ELR PPDUs. In this scenario, STA3 200cmay be able to hear STA2 200b(e.g., if STA2 200a is transmitting a non-HT PPDU). For example, STA3 200c may conduct a Request-To-Transmit (RTS)/Clear-To-Transmit (CTS) frame exchange or an initial control frame (ICF)/initial control response (ICR) frame exchange in non-HT PPDUs with STA2 200b. However, STA3 is not within the extended range PPDU 220 or ELR PPDU transmission range of STA1 200c and, therefore, cannot hear transmission using ELR PPDUs to or from STA1 200a. Therefore, STA3 200cmay not hear a transmission between STA1 200a and STA2 200b, for example, which may result in STA3 200c interfering with the transmission.

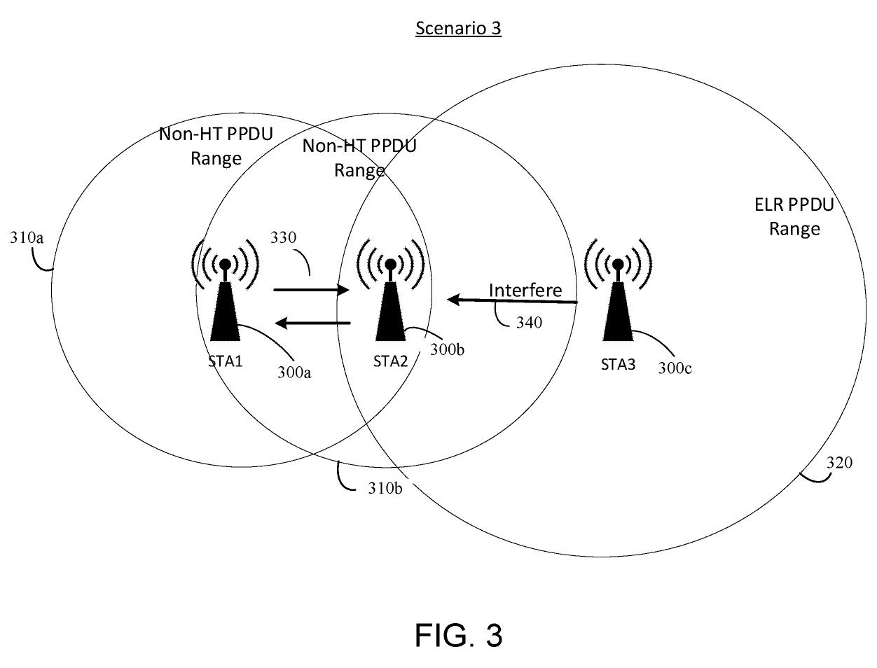

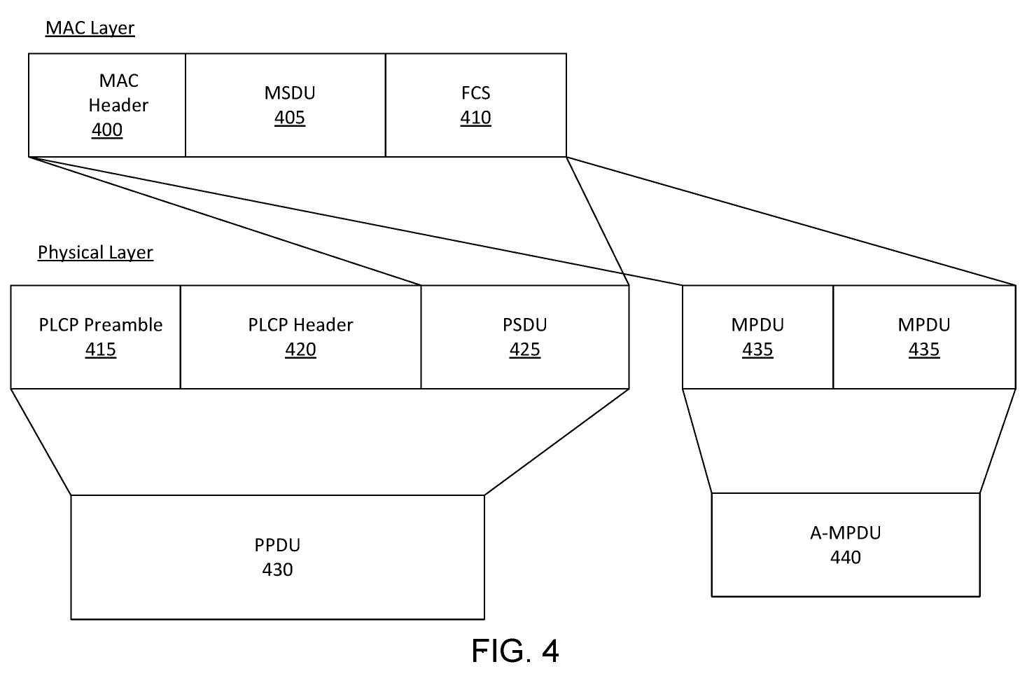

However, the coverage ranges of the normal transmission (e.g., non-HT PPDU transmission carried by legacy PPDUs) and long-range transmission (e.g., ELR PPDU transmission carried by long-range PPDU) from a STA are different. STAs within the range of long-range transmission but out of the range of the normal transmission may not be protected by the traditional RTS/CTS, which are carried in legacy PPDUs. This example is shown in scenario 3 of FIG. 3. In this example, STA1 300a and STA2 300b are protected by traditional RTS/CTS in non-HT PPDUs transmitted in the non-HT PPDU range 310a, 310b. A long-range capable STA, STA3 300c, may not hear the RTS/CTS transmissions from STA1 300a and STA2 300b and may transmit transmission 340 that interferes with the transmission 330 between STA1 300a and STA2 300b.

In MAC layer, there may be three types of MPDUs: 1) data frames carry data passing from the higher layers to the physical layer, 2) management frames for network management, 3) and control frames for medium access control. Additionally, the 802.11 physical layer may be composed of two sublayers: 1) the physical layer convergence procedure (PLCP) sublayer, and 2) the physical medium dependent (PMD) sublayer. The PLCP prepares the packet for transmission by taking the frame from the MAC sublayer and creating Physical Layer Data Unit (PPDU) 430. The PMD sublayer then modulates and transmits the data as bits.

When the MPDU 435 is handed down to the physical layer it is then referred to as PLCP Service Data Unit (PSDU) 425. The PPDU 430 is composed of a PLCP preamble 415, a PLCP header 420, and the PSDU 425. Different 802.11 amendments may have different PPDU formats, such as non-HT PPDUs (defined before 802.11n), HT PPDUs (defined in 802.11n), VHT PPDUs (defined in 802.11ac), HE PPDUs (defined in 802.11ax), EHT PPDUs (defined in 802.11be) and UHR PPDUs (defined in 802.11bn).

There have been conventional methods proposed to address long range transmission protection issues in a wireless networks. However, none of the conventional methods provide adequate solutions for providing long range transmission protection.

In one convention method, an initial control frame (ICF) and an initial response frame (ICR) may be carried in non-HT (Duplicate) PPDUs or ELR PPDUs. The ICF may be RTS frame, Multi-User (MU)-RTS frame, Buffer Status Report (BSRP) Trigger frame, BSRP GI3 Trigger frame (i.e., a special version of a BSRP frame), Trigger frame, CTS-To-Self frame or the like. Additionally, the ICR may be a CTS frame, a multi-STA Block Acknowledgement (BA) frame or the like. The BSRP frame and MU-RTS frame may also be trigger frames. The PPDUs carrying the ICF/ICR frames may be non-HT (Duplicate) PPDUs even though one or more following the PPDUs in the same Transmit Opportunity (TXOP) may be ELR PPDUs. Legacy STAs may understand the ICF/ICR or understand the MAC header of the ICF/ICR, and based on such understanding(s) may set a Network Allocation Vector (NAV) based on the received information. The STAs out of the coverage range of the non-HT (Dup) PPDU but within the range of the ELR PPDU may not be able to set the NAV accordingly since they may not decode the ICF/ICR carried by the non-HT (Dup) PPDU. Without the NAV being appropriately set, such STAs may transmit and interfere with the upcoming ELR transmissions.

In another conventional method, the PPDU carrying the ICF/ICR may be the same as the PPDU carrying the data/acknowledgement frame exchanges, respectively. For example, if the data frame will be carried by a non-HT Dup PPDU, and the responding frame will be carried by an ELR PPDU, then the ICF may be carried by a non-HT (Dup) PPDU, and the ICR may be carried in an ELR PPDU. If the data frame will be carried in an ELR PPDU and the responding frame will be carried by a non-HT Dup PPDU, then the ICF may be carried by an ELR PPDU, and the ICR may be carried in a non-HT (Duplicate) PPDU. Additionally, in 2.4GHz, if both the data and acknowledgement frames will be carried by the ELR PPDUs, the ICF may be carried by an ELR PPDU, and the ICR may be carried in an ELR PPDU. This method may provide protection from Ultra High Reliability(UHR)/UHR+ STAs. EHT STAs may be able to understand the USIG field and obtain the correct TXOP duration values. Thus, the method may provide protection from EHT STAs as well. However, pre-EHT STAs may not understand the ELR PPDUs, and they may not set NAV based on the ELR PPDUs and interfere with the upcoming data/acknowledge transmissions.

In another conventional method, when the legacy ICF/ICR frames are used, e.g., RTS/CTS, the ICF/ICR may be carried in non-HT Dup PPDUs. When the ICF/ICR frames defined in HE/HE+ are used, e.g., MU-RTS/M-BA, BSRP (Multi-User Block Acknowledgment (M-BA), or BSRP GI3/M-BA, the ICF/ICR may be carried in non-HT Dup PPDUs or ELR PPDUs depending on the types of PPDU carrying the upcoming data/acknowledgement transmissions or the types of TXOP. Here HE+ includes frames defined in 802.11be (i.e., EHT), 802.11bn (i.e., UHR), or a further generation (i.e., UHR+). Additionally, the ICF/ICR may be transmitted between APs for Multi-AP Coordinated (MAPC) negotiations and transmissions. The PPDUs that carries the ICF/ICR may be determined by the transmitting APs. APs may use long range PPDUs such as ELR PPDU or TB PPDU with DRU for MAPC negotiation and transmissions. However, the same hidden node problem may still exist for the above use cases.

The protections methods disclosed and described herein may be used to protect frame exchanges between multiple APs. For example, the NAV setting of the ICFs/ICRs may cover to the end of the ICR transmission, and the PPDUs that carry the ICF/ICR may be determined by the transmitting STAs. In one method the NAV setting of the ICFs/ICRs may cover to the end of the MAPC TXOP.

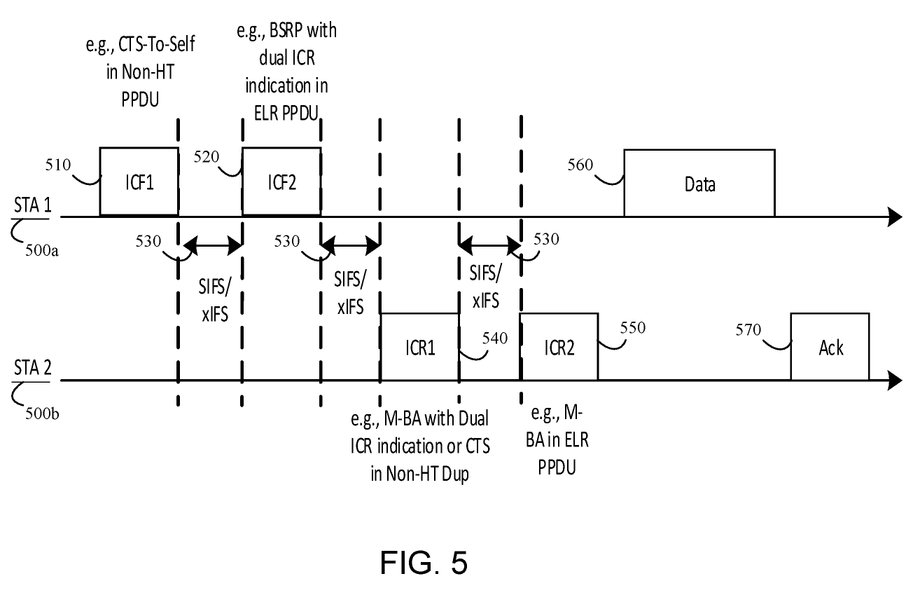

The embodiments covered by FIG. 5 address the problems in the conventional methods discussed above. FIG. 5 is a diagram illustrating an example of dual transmission for providing long range transmission protection in a wireless network. The example of FIG. 5, for instance, may be well suited for dual ICF and/or dual ICR transmissions for ELR/Distributed Resource Unit (DRU) or long-range transmission protections.

As an overview, two ICF frames may be transmitted by the initiating STA. The first ICF may be carried by a non-HT (Dup) PPDU and the second ICF may be carried by an ELR PPDU or other type of long-range PPDU. The first ICF frame may or may not be the same as the second ICF frame. In response, two ICR frames may be transmitted by the responding STA. The first ICR may be carried by a non-HT (Dup) PPDU and the second ICR may be carried by an ELR PPDU or other types of long-range PPDU. The first ICR frame may or may not be the same as the second ICR frame.

In an embodiment, STAs which have dual ICF/ICR or long-range protection capability may indicate their capability in an element, e.g., UHR Capabilities element. In an embodiment, APs may enable/disable the dual ICF/ICR or long-range protection for the BSS by explicitly indicating that in a field carried in an operation element, e.g., UHR Operation element. In an embodiment, STAs may enable/disable the dual ICF/ICR or long-range protection by explicitly indicating that in a field carried in a frame, e.g., UHR Notification Action frame. If an AP enables the dual ICF/ICR or long-range protection, it may perform dual ICF/ICR or long-range protection when the intended receiving STA(s) may enable the dual ICF/ICR or long-range protection. If an AP enables the dual ICF/ICR or long-range protection, a non-AP STA, which enables the dual ICF/ICR or long-range protection, may perform dual ICF/ICR or long-range protection when it transmits to the AP. If an AP disables the dual ICF/ICR or long-range protection, all the non-AP STAs may not use the dual ICF/ICR or long-range protection features.

A more detailed example of the dual ICF/ICR sequence for long range transmission protection, as described above, is shown in FIG. 5. In the example embodiments covered by FIG. 5, both STA1 500a and STA2 500b are capable of long-range protection and have enabled long-range protection.

STA1 500a may acquire the wireless medium using Enhanced Distributed Channel Access (EDCA) or Carrier Sense Multiple Access with Collision Avoidance (CSMA/CA) or other type of channel access mechanism allowed.

As shown in FIG. 5, STA1 500a may transmit a first ICF frame, e.g., the ICF1 510, carried in a non-HT (Dup) PPDU. The ICF1 510 may be a CTS-To-Self frame addressed to itself or the ICF1 510 may be a modified CTS-To-Self frame. The CTS-To-Self frame or modified CTS-To-Self frame is used to reserve the channel, rather than soliciting a response from STA2 500b. In an embodiment, the ICF1 510 may be a MU-RTS frame or a BSRP frame or a modified version of the above-mentioned frame, and the Receiver Address (RA) field of the frame may be set to STA1’s MAC address or a broadcast address. The Association Identifier (AID)12 (e.g., 12 least significant bits of the AID of the intended STA) field in a User Info field of the MU-RTS/BSRP frame may be set to STA1’s AID or a reserved AID value so that no STAs will be triggered and transmit immediately after the ICF1 510.

In an embodiment, the ICF1 510 may be an RTS frame and the RA field of the RTS frame may be set to STA1’s MAC address. Additionally, STA1 500a may set a Duration field of the ICF1 510, which carries the NAV, to cover the entire Transmit Opportunity (TXOP). In an embodiment, STA1 500a may set the Duration field of the ICF1 510 to cover a second ICR transmission from STA2 500b. In an embodiment, a Dual ICF/ICR Indication field/bit may be carried in the ICF1 510 frame or the PPDU carrying the ICF1 510, or the Dual ICF/ICR Indication field/bit may be carried in MAC frame. In an embodiment, the Dual ICF/ICR indication field/bit may be carried in MAC header, or the Dual ICF/ICR Indication field/bit may be carried in the Physical Layer (PHY) header. The Dual ICF/ICR Indication field/bit may indicate a second ICF frame may follow the transmission of the ICF1 510.

Referring to FIG. 5, after a Short Inter-Frame Spacing (SIFS) time, Point Coordination Function Inter-Frame Spacing (PIFS) time, or Extended Inter-Frame Spacing (xIFS) time 530, STA1 500a may transmit a second ICF frame 520, i.e., ICF2 520, carried in an ELR PPDU. SIFS time, PIFS time, or xIFS time may be used interchangeably herein and may refer to any inter-frame spacing (temporally), including a newly defined inter-frame spacing after the end of a PPDU, such as the PPDU carrying the ICF1 510.

In an embodiment, ICF2 520 may be a BSRP frame, a BSRP GI3 frame, or a MU-RTS frame or modified version of above-mentioned frames. The RA field of ICF2 520 may be set to the intended recipient address, i.e., STA2’s MAC address.

In an embodiment, the RA field of ICF2 520 may be set to a broadcast address, and the AID12 field in a User Info field of the BSRP, BSRPGI3, or MU-RTS frame may indicate STA2’s AID. More than one recipient may be supported. For example, STA2 500b may include a set of STAs, and the Resource Unit (RU) Allocation field in the corresponding User Info field may contain assigned RUs for the STAs in the set of STAs of STA2 500b to transmit the ICR2 550. The PHY header of the ELR PPDU carrying the ICF2 520 may carry the detailed bandwidth and punctured channel information to the intended recipient(s) and unintended recipients.

In an embodiment, ICF2 520 may carry a Dual ICF/ICR indication field/bit to request dual ICR transmissions from the responding STAs. The indication may be carried in the MAC frame, the MAC header, or the PHY header. In an embodiment, ICF2 520 may carry necessary information to enable an operation mode, such as dynamic power save mode, Enhanced Multi-link Single-Radio (EMLSR) mode, Enhanced Multi-link Multi-Radio (EMLMR) mode, dynamic unavailability poll, Non-Primary Channel access (NPCA) or the like. These embodiments are not limited to the examples provided and may be used to enable coexistence of long-range transmission with other modes as well. In an embodiment, the ICF2 520 may be omitted, if the upcoming transmission from STA1 500a in the same TXOP is not a long-range transmission. Additionally, the Duration field of ICF2 520 may be set to the duration value of ICF1 510 minus SIFS (or xIFS) 530 and minus transmission time duration of the ICF2 520.

As shown in FIG. 5, upon reception of the ICF1 510 and/or ICF2 520, STA2 500b may ignore the NAV set by the ICF1 510 under the condition that the ICF2 520 is addressed to STA2 500b. On the other hand, STA2 500bmay check its NAV setting and/or Clear Channel Assessment (CCA). If NAV is 0 and/or CCA is clear, STA2 500b may transmit the first ICR, e.g., ICR1 frame 540, in a non-HT (Dup) PPDU, a SIFS (PIFS or xIFS) time 530 after the ICF2 520 is transmitted from STA1 500a.

In an embodiment, the ICR1 frame 540 may be a multi-STA Block Acknowledgement (BA) frame or a modified multi-STA BA frame which may be addressed to STA1 500a. In an embodiment, the ICR1 frame 540 may be a CTS frame or a modified CTS frame which may be addressed to STA1 500a, and a Dual ICR indication field/bit may be carried in the ICR1 frame 540. For example, it may be carried in the MAC frame body or MAC header of the ICR1 frame 540, and the Dual ICR indication field/bit indication may be used to explicitly indicate there will be another ICR frame after the current transmission.

In an embodiment, if the ICF2 520 is transmitted to multiple STAs, (i.e., STA2 may be a set of STAs), the ICR1 frame 540 may carry the same contents so that the ICR1 frame 540 transmitted by multiple STAs may be identical, and STA1 500a may be able to decode it. The RA field of the ICR1 frame 540 may be set to STA1’s MAC address, and STA2 500b may set Duration field of the ICR1 540 based on the Duration value received from ICF1 510 and/or ICF2 520. Additionally, the Modulation and The Coding Scheme (MCS) used to transmit ICR1 frame 540 may be the same as MCS used for transmitting ICF1 510.

In an embodiment, if STA1 500a does not receive or detect the ICR1 frame 540 during a CTSTimeout interval (e.g., a CTSTimout is a parameter defined as a SIFSTime + aSlotTime + aRxPHYStartDelay) from the end of the ICF2 520 transmission, STA1 500a may conclude that the transmissions of the ICF1 510 and/or ICF2 520 has failed, and may invoke its backoff procedure on expiration of the CTSTimeout interval.

Referring to FIG. 5, after the SIFS time, PIFS time, or xIFS time 530 (e.g., the SIFS time, PIFS time, or xIFS time 530 after the end of the PPDU carrying the ICR1 frame 540), STA2 500b may transmit a second ICR frame, i.e., the ICR2 frame 550, carried in an ELR PPDU or Trigger-Based (TB) PPDU with Distributed Resource Unit (DRU) allocation. In an embodiment, the ICR2 frame 550 may be a multi-STA BA frame or a modified multi-STA BA frame which may be addressed to STA1 500a.

In an embodiment, the ICR2 frame 550 may be a CTS frame or a modified CTS frame which may be addressed to STA1 500a. If the ICF2 520 is transmitted to multiple STAs, (i.e., STA2 500b may be a set of STAs), the ICR2 frame 550 may carry the same contents so that the ICR2 frame 550 transmitted by multiple STAs may be identical, and STA1 500a may be able to decode it. In this embodiment, the ICR2 frame 550 may be transmitted using ELR PPDU. Additionally, the MCS used to transmit ICR2 frame 550 may be the same as the MSC used to transmit ICF2 520.

In an embodiment, if the ICF2 frame 550 is transmitted to multiple STAs, (i.e., STA2 500b includes a set of STAs) and ICF2 520 is a trigger frame with multiple User Info fields and one or more User Info field carries RU allocation, the ICR2 frame 550 may be carried on the assigned RU. In this case, the ICR2 frame 550 may be transmitted using TB PPDU. Additionally, the MCS used to transmit the ICR2 frame 550 may be assigned by STA1 500a in ICF2 520.

In an embodiment, the RA field of the ICR2 frame 550 may be set to STA1’s MAC address. STA2 500b may set the Duration field of the ICR2 frame 550 to a Duration value set for the ICR1 frame 540 minus the SIFS (PIFS or xIFS) duration and minus time duration to transmit ICR2 frame 550 in the PPDU.

In an embodiment, the transmission of the ICR2 frame 550 may be omitted if the upcoming response transmission from STA2 500b in the same TXOP is not to be a long-range transmission. Additionally, if STA1 500a expects to receive the second ICR frame, ICR2 frame 550, and does not receive or detect the ICR2 frame 550 during CTSTimeout interval from the end of the ICR1 frame 540 transmission, STA1 may conclude that the transmission of the ICR2 frame 550 has failed and may invoke its backoff procedure on expiration of the CTSTimeout interval.

Referring again to FIG. 5, upon successful reception of the ICR1 frame 540 and/or the ICR2 frame 550 from STA 2 500b, STA1 500a may start to transmit data 560 to STA2 500b, and STA2 500b may respond with an acknowledgement 570 and/or reverse direction transmissions. The transmitting of data to STA2 500b may be based on the ICR1 frame 540 and/or the ICR2 frame 550 indicating an availability to receive data and/or the ICR1 frame 540 and/or the ICR2 frame 550, respectively, including information indicating an availability to receive data. Using the embodiments described, with reference to FIG. 5, data can be reliably transmitted between STA1 and STA 2 without interference from other STAs regardless of whether the wireless network includes both non-HT STAs (e.g., legacy STAs) and ELR STAs.

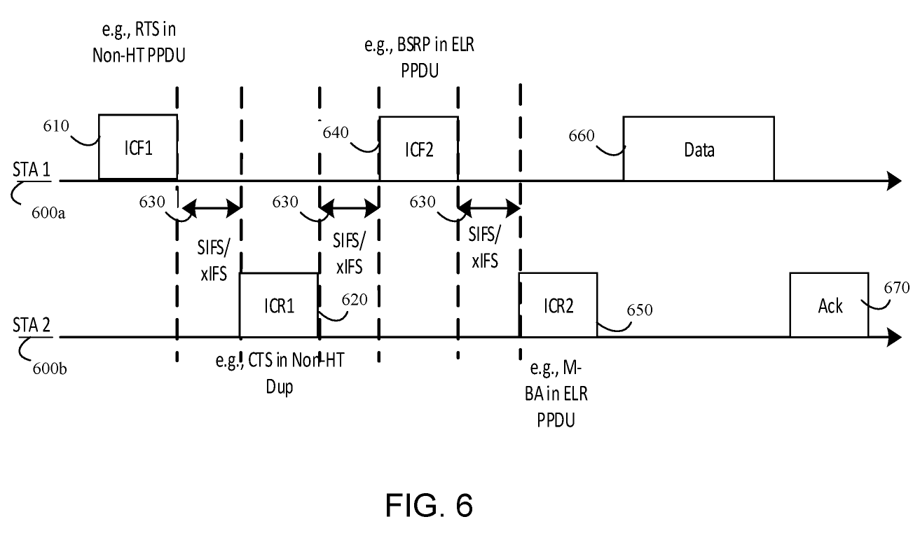

As shown in FIG. 6, STA1 600a may transmit a first ICF frame, e.g., the ICF1 610, carried in a non-HT (Dup) PPDU. In an embodiment, the ICF1 610 may be a RTS frame addressed to STA2 600b or a modified RTS frame. Additionally, ICF1 610 may be a MU-RTS frame or a BSRP frame or a modified version of the above-mentioned frame, and the Receiver Address (RA) field of the frame may be set to STA2’s MAC address or a broadcast address. The Association Identifier (AID)12 (e.g., 12 least significant bits of the AID of the intended STA) field in a User Info field of the MU-RTS/BSRP frame may be set to STA2’s AID.

In an embodiment, STA1 600a may set a Duration field of the ICF1 610, which carries the NAV, to cover the entire Transmit Opportunity (TXOP). In an embodiment, STA1 600a may set the Duration field of the ICF1 610 to cover a first ICR transmission from STA2 600b. In an embodiment, a Dual ICF/ICR Indication field/bit may be carried in the ICF1 610 frame or the PPDU carrying the ICF1 610 to indicate that a ICF2/ICR2 frame exchange may follow the ICR1 frame 620. In an embodiment, the ICF/ICR Indication field/bit may be carried in MAC frame. In an embodiment, the ICF/ICR indication field/bit may be carried in MAC header, or the ICF/ICR Indication field/bit may be carried in the Physical Layer (PHY) header. The ICF/ICR Indication field/bit may indicate a second ICF frame may follow the transmission of the ICF1 610.

Referring to FIG. 6, upon reception of the ICF1 610, STA2 600b may check its NAV setting and/or Clear Channel Assessment (CCA). If NAV is 0 and/or CCA is clear, STA2 600b may transmit the first ICR, e.g., ICR1 frame 620, in a non-HT (Dup) PPDU, a SIFS (PFIS or xIFS) time 630 after the ICF1 610 is transmitted from STA1 600a. The SIFS time 630 (PIFS time or xIFS time) here may be any inter-frame spacing including newly defined inter-frame spacing. In an embodiment, the ICR1 frame 620 may be a CTS frame or a modified CTS frame which may be addressed to STA1 600a, or ICR1 frame 620 may be a multi-STA BA frame or a modified multi-STA BA frame which may be addressed to STA1 600a.

In an embodiment, a Dual ICR indication field/bit may be carried in the ICR1 frame 620. For example, it may be carried in the MAC frame body or MAC header of the ICR1 frame 620, and the Dual ICR indication field/bit indication may be used to explicitly indicate that STA2 600b will transmit another ICR frame if it receives another ICF. The Dual ICR indication field/bit may be set to the same value as that set in the ICF1 610 frame.

In an embodiment, if the ICF1 610 is transmitted to multiple STAs, (i.e., STA2 may be a set of STAs), the ICR1 frame 620 may carry the same contents so that the ICR1 frame 620 transmitted by multiple STAs may be identical, and STA1 600a may be able to decode it. The RA field of the ICR1 frame 620 may be set to STA1’s MAC address, and STA2 600b may set Duration field of the ICR1 620 based on the Duration value received from ICF1 610.

In an embodiment, STA2 600b may set a Duration field of the ICR1 620 based on the Duration value received from ICF1 610. For example, Duration_ICR1 may be set to duration value obtained in_ICF1 minus SIFS (xIFS) time and minus time duration for PPDU carrying ICR1 610. Additionally, the Modulation and The Coding Scheme (MCS) used to transmit ICR1 620 may be the same as the MCS used to transmit ICF1 610.

In an embodiment, if STA1 600a does not receive or detect ICR1 frame 620 during a CTSTimeout interval from the end of the ICF1 610 transmission, STA1 600a may conclude that the transmission of the ICF1 610 has failed and may invoke its backoff procedure on expiration of the CTSTimeout interval.

Referring to FIG. 6, after the reception of the ICR1 620 successfully, STA1 600a may transmit a second ICF, e.g., the ICF2 640, in a ELR PPDU, a SIFS (PFIS or xIFS) time 630 after the ICR1 620 is transmitted from STA 2 600b. In an embodiment, ICF2 640 may be a BSRP frame, a BSRP GI3 frame, or a MU-RTS frame or modified version of above-mentioned frames. The RA field of ICF2 640 may be set to the intended recipient address, i.e., STA2’s MAC address.

In an embodiment, the RA field of ICF2 640 may be set to a broadcast address, and the AID12 field in a User Info field of the BSRP, BSRPGI3, or MU-RTS frame may indicate STA2’s AID. With this embodiment, more than a recipient may be supported. For example, STA2 600b may include a set of STAs, and the Resource Unit (RU) Allocation field in the corresponding User Info field may contain assigned RUs for the STAs in the set of STAs of STA2 600b to transmit the ICR2 frame 650. The PHY header of the ELR PPDU carrying the ICF2 640 may carry the detailed bandwidth and punctured channel information to the intended recipient(s) and unintended recipients.

In an embodiment, ICF2 640 may carry a Dual ICF/ICR indication field/bit to indicate that this is the second ICF from STA1 600a and/or a second ICR frame from STA2 600b is expected. The indication may be carried in the MAC frame, the MAC header, or the PHY header. In an embodiment, ICF2 640 may carry necessary information to enable an operation mode, such as dynamic power save mode, Enhanced Multi-link Single-Radio (EMLSR) mode, Enhanced Multi-link Multi-Radio (EMLMR) mode, dynamic unavailability poll, Non-Primary Channel access (NPCA) or the like. This embodiment is noted limited to the examples provided and may be used to enable coexistence of long-range transmission with other modes as well.

In an embodiment, the ICF2 640 may be omitted, if the upcoming transmission from STA1 600a in the same TXOP is not a long-range transmission. The Duration field of ICF2 640 may be set to the duration value of ICR1 frame 620 minus SIFS (or xIFS) 630 and minus transmission time duration of the ICF2 640. The Duration field of ICF2 640 may be set to cover the entire TXOP (covering upcoming data and acknowledgement transmissions), or the Duration field of ICF2 640 may be set to cover the end of ICR2 transmission.

Referring to FIG. 6, after the SIFS time, PIFS time, or xIFS time 630 (e.g., the SIFS time, PIFS time, or xIFS time 630 after the end of the PPDU carrying the ICR1 frame 620), STA2 600b may transmit a second ICR frame, i.e., the ICR2 frame 650, carried in an ELR PPDU or Trigger-Based (TB) PPDU with Distributed Resource Unit (DRU) allocation.

In an embodiment, the ICR2 frame 650 may be a multi-STA BA frame or a modified multi-STA BA frame which may be addressed to STA1 600a. In an embodiment, the ICR2 frame 650 may be a CTS frame or a modified CTS frame which may be addressed to STA1 600a. If the ICF2 640 is transmitted to multiple STAs, (i.e., STA2 600b may be a set of STAs), the ICR2 frame 650 may carry the same contents so that the ICR2 frame 650 transmitted by multiple STAs may be identical, and STA1 600a may be able to decode it. In this embodiment, the ICR2 frame 650 may be transmitted using ELR PPDU. Additionally, the MCS used to transmit ICR2 frame 650 may be the same as the MSC used to transmit ICF2 640.

In an embodiment, if the ICF2 640 is transmitted to multiple STAs, (i.e., STA2 600b includes a set of STAs) and ICF2 640 is a trigger frame with multiple User Info fields and one or more User Info field carries RU allocation, the ICR2 frame 650 may be carried on the assigned RU. In this case, the ICR2 frame 650 may be transmitted using TB PPDU. Additionally, the MCS used to transmit the ICR2 frame 650 may be assigned by STA1 600a in ICF2 620.

In an embodiment, the RA field of the ICR2 frame 650 may be set to STA1’s MAC address. STA2 600bmay set the Duration field of the ICR2 frame 650 to a Duration value set for the ICF2 640 minus SIFS (or xIFS) duration and minus time duration to transmit the ICR2 frame 650 in the PPDU.

In an embodiment, the transmission of the ICR2 frame 650 may be omitted if the upcoming response transmission from STA2 600b in the same TXOP is not a long-range transmission. Additionally, if STA1 600a expects to receive the ICR2 frame 650, and does not receive or detect the ICR2 frame 650 during CTSTimeout interval from the end of the ICF2 640 transmission, STA1 600a may conclude that the transmission of the ICR2 frame 650 has failed and may invoke its backoff procedure on expiration of the CTSTimeout interval.

Referring again to FIG. 6, upon successful reception of the ICR2 frame 650 from STA 2 600b, STA1 600a may start to transmit data 660 to STA2 600b, and STA2 600b may respond with an acknowledgement 670 and/or reverse direction transmissions. The transmitting of data to STA2 600b may be based on the ICR2 frame 650 indicating an availability to receive data and/or the ICR2 frame 650 including information indicating an availability to receive data.

Using the embodiments described, with reference to FIG. 6, data can be reliably transmitted between STA1 600a and STA 2600b without interference from other STAs regardless of whether the wireless network includes both non-HT STAs (e.g., legacy STAs) and ELR STAs.

In another embodiment, with reference to FIGS. 5 and 6, STA1 500a, 600a may be an AP and STA2 500b, 600bmay be a non-AP STA and the data transmission in ELR PPDU may be a downlink transmission. Additionally, STA1 500a, 600a may be a non-AP STA and STA2 500b, 600b may be an AP and the data transmission in ELR PPDU may be an uplink transmission. In another embodiment, both STA1 500a, 600a and STA2 500b, 600b may be non-AP STAs and the data in ELR PPDU may be a Peer-To-Peer (P2P) transmission, or both STA1 500a, 600a and STA2 500b, 600b may be APs and the data in ELR PPDU may be a management/negotiation transmission between APs. Although ELR PPDUs are used in the above examples of FIGS. 5 and 6, it is contemplated that the ELR PPDU may be replaced by other types of long-range PPDUs. Additionally, although CTSTimeout intervals are used as a predefined time interval for a STA to determine the transmission failure occurring and invoke the backoff procedure in the examples of FIGS. 5 and 6, it is further contemplated that other or a new timeout intervals may be defined and used instead.

After a SIFS time, PIFS time, or xIFS time (e.g., 530) (SIFS time, PIFS time, or xIFS time after the end of the PPDU carrying the first ICF), in step S710, the first STA may transmit a second PPDU carrying a second frame (e.g., ICF2 520). The second PPDU is defined for use with a second transmission range and the second transmission range extends beyond the first transmission range. For example, the second PPDU may be an enhanced long range (ELR) PPDU or a distributed resource unit (DRU) PPDU. Additionally, at least one of the first frame or the second frame may be, respectively, first and second information for soliciting a response from the second STA.

For example, the first frame may be a first ICF in the first PPDU and the second frame may be a second ICF in the second PPDU. The first ICF may be a CTS-To-Self frame addressed to itself, or a modified CTS-To-Self frame. The CTS-To-Self frame or modified CTS-To-Self frame is used to reserve the channel, rather than soliciting a response from the second STA. In an embodiment, the first ICF and the second ICF may be a MU-RTS frame, an RTS frame, or a BSRP frame or a modified version of the above-mentioned frames. Additionally, the first frame may include an indication of dual transmission such that the second frame is to be transmitted after the first frame, and the first frame or the second frame includes an indication requesting similar dual transmission from the second STA. For example, a Dual ICF/ICR Indication field/bit may be carried in the first frame or the second frame or the PPDUs carrying the first frame and the second frame, or the Dual ICF/ICR Indication field/bit may be carried in a MAC frame. In an embodiment, the Dual ICF/ICR indication field/bit may be carried in MAC header, or the Dual ICF/ICR Indication field/bit may be carried in the Physical Layer (PHY) header. Additionally, the Dual ICF/ICR Indication field/bit may indicate a second ICF frame may follow the transmission of the first ICF frame. In one embodiment, the first ICF and the second ICF from the first STA may be different ICFs.

Upon reception of the first PPDU or the second PPDU, the second STA may check its NAV setting and/or Clear Channel Assessment (CCA). If NAV is 0 (e.g., or null) and/or CCA is clear, the second STA may transmit a third PPDU including a third frame (e.g. ICR1 frame 540) to the first STA, a SIFS (PFIS or xIFS) time (e.g., 530) after the first and second PPDUs are transmitted from the first STA. The third PPDU may be a non-HT (Dup) PPDU and is defined for using with the first transmission range.

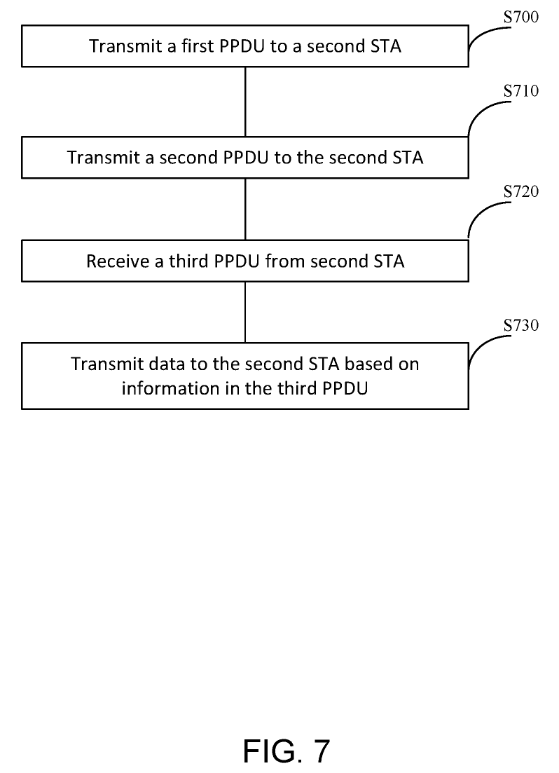

As shown in FIG. 7, in steps S720, the first STA receives the third PPDU from the second STA including a third frame. In an embodiment, the third frame is a third ICR frame (e.g., ICR1 frame 540) and the third ICR frame may be a multi-STA Block Acknowledgement (M-BA) frame or a modified multi-STA BA frame which may be addressed to first STA. In an embodiment, the third ICR frame may be a CTS frame or a modified CTS frame which may be addressed to first STA. Additionally, a Dual ICR indication field/bit may be carried in the third ICR frame. For example, it may be carried in the MAC frame body or MAC header of the ICR1 frame 540, and the Dual ICR indication field/bit indication may be used to indicate there will be another ICR frame after the current transmission.

In FIG. 7, in step S730, the first STA transmits data to the second STA based on the information in the third frame of the third PPDU, which indicates availability to receive data from the first STA. The transmitting of data to the second STA may be based on the third PPDU indicating an availability to receive data and/or the third PPD including information indicating an availability to receive data.

In this case, it was not necessary for the STA to receive a fourth PPDU from the second STA because the third PPDU included an indication of the second STA’s availability to receive data. For example, the third ICR frame from the second STA may be a CTS frame or a modified CTS frame addressed to the first STA indicating availability to receive data.

Using the embodiments described, with reference to FIG. 7, data can be reliably transmitted between the first STA and the second STA without interference from other STAs regardless of whether the wireless network includes both non-HT STAs (e.g., legacy STAs) and ELR STAs.

After a SIFS time, PIFS time, or xIFS time (e.g., 530) (SIFS time, PIFS time, or xIFS time after the end of the PPDU carrying the first ICF), in step S810, the first STA may transmit a second PPDU carrying a second frame (e.g., ICF2 520). The second PPDU is defined for use with a second transmission range and the second transmission range extends beyond the first transmission range. For example, the second PPDU may be an enhanced long range (ELR) PPDU or a distributed resource unit (DRU) PPDU. Additionally, at least one of the first frame or the second frame may be, respectively, first and second information for soliciting a response from the second STA.

For example, the first frame may be a first ICF in the first PPDU and the second frame may be a second ICF in the second PPDU. The first ICF may be a CTS-To-Self frame addressed to itself, or a modified CTS-To-Self frame. The CTS-To-Self frame or modified CTS-To-Self frame is used to reserve the channel, rather than soliciting a response from the second STA. In an embodiment, the first ICF and the second ICF may be a MU-RTS frame, an RTS frame, or a BSRP frame or a modified version of the above-mentioned frames. Additionally, the first frame may include an indication of dual transmission such that the second frame is to be transmitted after the first frame, and the first frame or the second frame includes an indication requesting similar dual transmission from the second STA. For example, a Dual ICF/ICR Indication field/bit may be carried in the first frame or the second frame or the PPDUs carrying the first frame and the second frame, or the Dual ICF/ICR Indication field/bit may be carried in a MAC frame. In an embodiment, the Dual ICF/ICR indication field/bit may be carried in MAC header, or the Dual ICF/ICR Indication field/bit may be carried in the Physical Layer (PHY) header. Additionally, the Dual ICF/ICR Indication field/bit may indicate a second ICF frame may follow the transmission of the first ICF frame. In an embodiment, the first ICF and the second ICF from the first STA may be different ICFs.

Upon reception of the first PPDU or the second PPDU, the second STA may check its NAV setting and/or Clear Channel Assessment (CCA). If NAV is 0 and/or CCA is clear, the second STA may transmit a third PPDU including a third frame (e.g. ICR1 frame 540) to the first STA, a SIFS (PFIS or xIFS) time (e.g., 530) after the first and second PPDUs are transmitted from the first STA. The third PPDU may be a non-HT (Dup) PPDU and is defined for using with the first transmission range.

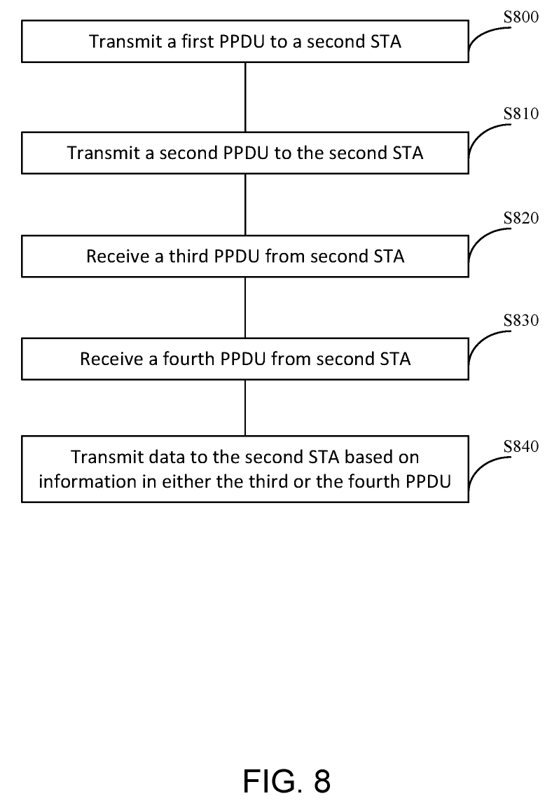

As shown in FIG. 8, in steps S820, the first STA receives the third PPDU from the second STA including a third frame. In an embodiment, the third frame is a third ICR frame (e.g., ICR1 frame 540) and the third ICR frame may be a multi-STA Block Acknowledgement (M-BA) frame or a modified multi-STA BA frame which may be addressed to first STA. In an embodiment, the third ICR frame may be a CTS frame or a modified CTS frame which may be addressed to first STA. Additionally, a Dual ICR indication field/bit may be carried in the third ICR frame. For example, it may be carried in the MAC frame body or MAC header of the ICR1 frame 540, and the Dual ICR indication field/bit indication may be used to indicate there will be another ICR frame after the current transmission.

After a SIFS time, PIFS time, or xIFS time (e.g., time 530) (the SIFS time, PIFS time, or xIFS time after the end of the PPDU carrying the second ICF frame), the second STA may transmit a fourth PPDU including a fourth frame (e.g., the ICR2 frame 550). The fourth PPDU is defined for use with the second transmission range, and may be an ELR PPDU or Trigger-Based (TB) PPDU with Distributed Resource Unit (DRU) allocation. In an embodiment, the fourth frame includes a fourth ICR frame that may be a multi-STA BA frame or a modified multi-STA BA frame which may be addressed to the first STA. In an embodiment, the fourth ICR may be a CTS frame or a modified CTS frame which may be addressed to the first STA. If the fourth ICF frame is transmitted to multiple STAs, (i.e., second STA may be a set of STAs), the fourth ICR frame may carry the same contents so that the fourth ICR frame is transmitted by multiple STAs may be identical, and first STA may be able to decode it. In this embodiment, the fourth ICR frame may be transmitted using ELR PPDU.

In FIG. 8, in step S840, upon successful reception of the third PPDU or the fourth PPDU, the first STA may start to transmit data (e.g., data 560) to the second STA. The transmitting of data to the second STA may be based on the third or the fourth PPDU indicating an availability to receive data and/or the third or the fourth PPD including, respectively, information indicating an availability to receive data. The second STA may respond with an acknowledgement (e.g., 570) and/or reverse direction transmissions. Using the embodiments described, with reference to FIG. 8, data can be reliably transmitted between the first STA and the second STA without interference from other STAs regardless of whether the wireless network includes both non-HT STAs (e.g., legacy STAs) and ELR STAs.

The first STA transmits data to the second STA based on the information in the third frame of the third PPDU, which indicates availability to receive data from the first STA. In this case, it was not necessary for the STA to receive a fourth PPDU from the second STA because the third PPDU included an indication of the second STA’s availability to receive data. For example, the third ICR frame from the second STA may be a CTS frame or a modified CTS frame addressed to the first STA indicating availability to receive data.

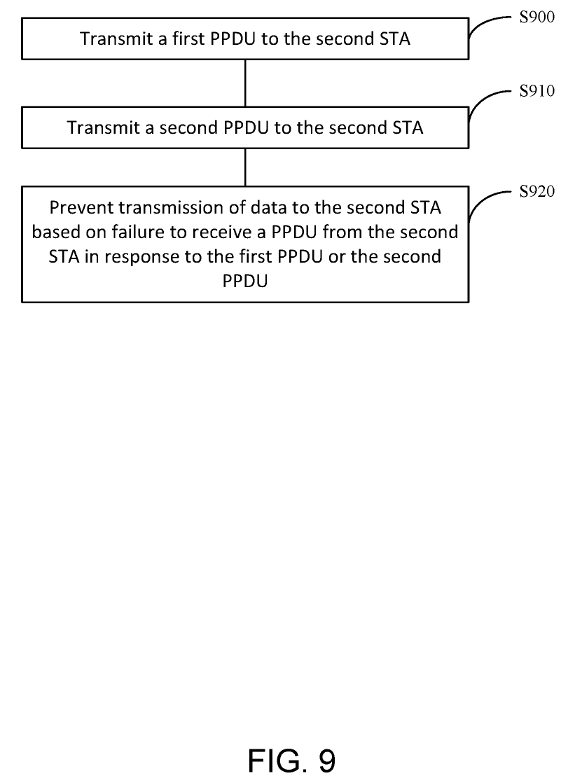

As shown FIG. 9, in step S900, a first STA (e.g., STA1 500a) may transmit a first PPDU carrying a first frame (e.g., the ICF1 510) to a second STA (e.g., STA2 500b). The first PPDU is defined for use in a first transmission range. For example, the first PPDU may be a non-high throughput (non-HT) PPDU.

After a SIFS time, PIFS time, or xIFS time (e.g., 530) (SIFS time, PIFS time, or xIFS time after the end of the PPDU carrying the first ICF), in step S910, the first STA may transmit a second PPDU carrying a second frame (e.g., ICF2 520). The second PPDU is defined for use with a second transmission range and the second transmission range extends beyond the first transmission range. For example, the second PPDU may be an enhanced long range (ELR) PPDU or a distributed resource unit (DRU) PPDU. Additionally, at least one of the first frame or the second frame may be, respectively, first and second information for soliciting a response from the second STA.

For example, the first frame may be a first ICF in the first PPDU and the second frame may be a second ICF in the second PPDU. The first ICF may be a CTS-To-Self frame addressed to itself, or a modified CTS-To-Self frame. The CTS-To-Self frame or modified CTS-To-Self frame is used to reserve the channel, rather than soliciting a response from the second STA.

In an embodiment, the first ICF and the second ICF may be a MU-RTS frame, an RTS frame, or a BSRP frame or a modified version of the above-mentioned frames. Additionally, the first frame may include an indication of dual transmission such that the second frame is to be transmitted after the first frame, and the first frame or the second frame includes an indication requesting similar dual transmission from the second STA. For example, a Dual ICF/ICR Indication field/bit may be carried in the first frame or the second frame or the PPDUs carrying the first frame and the second frame, or the Dual ICF/ICR Indication field/bit may be carried in a MAC frame. In an embodiment, the Dual ICF/ICR indication field/bit may be carried in MAC header, or the Dual ICF/ICR Indication field/bit may be carried in the Physical Layer (PHY) header. Additionally, the Dual ICF/ICR Indication field/bit may indicate a second ICF frame may follow the transmission of the first ICF frame. In an embodiment, the first ICF and the second ICF from the first STA may be different ICFs.

In step S920, if the first STA does not receive and/or detect (e.g., decode) a response frame from the second STA such as a PPDU including an ICR frame during a CTSTimeout interval (e.g., a CTSTimout is a parameter defined as a SIFSTime + aSlotTime + aRxPHYStartDelay) from the end of the second PPDU transmission, the first STA1 may conclude that the transmissions of the first PPDU and/or the second PPDU has failed. The first STA may invoke a backoff procedure on expiration of the CTSTimeout interval, thereby preventing (e.g., forego, refrain from, or not perform) the transmission of data to the second STA.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and memory, the circuitry being operable (e.g., configured) to process the disclosed method, with a computer program product comprising program code instructions and with a non-transitory computer-readable storage medium storing program instructions. Besides, any characteristic, variant or embodiment described for an AP is compatible with a non-AP STA.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term "video" or the term "imagery" may mean any of a snapshot, single image and/or multiple images displayed over a time basis. As another example, when referred to herein, the terms "user equipment" and its abbreviation "UE", the term "remote" and/or the terms "head mounted display" or its abbreviation "HMD" may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit ("CPU") and memory. In accordance with the practices of persons skilled in the art of computer programming, reference to acts and symbolic representations of operations or instructions may be performed by the various CPUs and memories. Such acts and operations or instructions may be referred to as being "executed," "computer executed" or "CPU executed."

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively "associated" such that the desired functionality may be achieved. Hence, any two components herein combined to achieve a particular functionality may be seen as "associated with" each other such that the desired functionality is achieved, irrespective of architectures or intermedial components. Likewise, any two components so associated may also be viewed as being "operably connected", or "operably coupled", to each other to achieve the desired functionality, and any two components capable of being so associated may also be viewed as being "operably couplable" to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as "open" terms (e.g., the term "including" should be interpreted as "including but not limited to," the term "having" should be interpreted as "having at least," the term "includes" should be interpreted as "includes but is not limited to," etc.). It will be further understood by those within the art that if a specific number of an introduced claim recitation is intended, such an intent will be explicitly recited in the claim, and in the absence of such recitation no such intent is present. For example, where only one item is intended, the term "single" or similar language may be used. As an aid to understanding, the following appended claims and/or the descriptions herein may include usage of the introductory phrases "at least one" and "one or more" to introduce claim recitations. However, the use of such phrases should not be construed to imply that the introduction of a claim recitation by the indefinite articles "a" or "an" limits any particular claim including such introduced claim recitation to embodiments including only one such recitation, even when the same claim includes the introductory phrases "one or more" or "at least one" and indefinite articles such as "a" or "an" (e.g., "a" and/or "an" should be interpreted to mean "at least one" or "one or more"). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of "two recitations," without other modifiers, means at least two recitations, or two or more recitations). Furthermore, in those instances where a convention analogous to "at least one of A, B, and C, etc." is used, in general such a construction is intended in the sense one having skill in the art would understand the convention (e.g., "a system having at least one of A, B, and C" would include but not be limited to systems that have A alone, B alone, C alone, A and B together, A and C together, B and C together, and/or A, B, and C together, etc.). In those instances where a convention analogous to "at least one of A, B, or C, etc." is used, in general such a construction is intended in the sense one having skill in the art would understand the convention (e.g., "a system having at least one of A, B, or C" would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase "A or B" will be understood to include the possibilities of "A" or "B" or "A and B." Further, the terms "any of" followed by a listing of a plurality of items and/or a plurality of categories of items, as used herein, are intended to include "any of," "any combination of," "any multiple of," and/or "any combination of multiples of" the items and/or the categories of items, individually or in conjunction with other items and/or other categories of items. Moreover, as used herein, the term "set" is intended to include any number of items, including zero. Additionally, as used herein, the term "number" is intended to include any number, including zero. And the term "multiple", as used herein, is intended to be synonymous with "a plurality".

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as "up to," "at least," "greater than," "less than," and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms "means for" in any claim is intended to invoke 35 U.S.C. §112, ¶ 6 or means-plus-function claim format, and any claim without the terms "means for" is not so intended.

The content of each of the following references is incorporated by reference herein in its entirety:

IEEE Std 802.11™-2020: Part 11: Wireless LAN Medium Access Control (MAC) and Physical Layer (PHY) Specifications, December 2020, 149 pages.

Draft Standard for Information technology – Telecommunications and information exchange between systems Local and metropolitan area networks – Specific requirements; Part 11: Wireless LAN Medium Access Control (MAC) and Physical Layer (PHY) Specifications; Amendment 1: Enhancements for High Efficiency WLAN, IEEE P802.11ax/D8.0 (October 2020), 820 pages

Draft Standard for Information technology- Telecommunications and information exchange between systems Local and metropolitan area networks - Specific requirements; Part 11: Wireless LAN Medium Access Control (MAC) and Physical Layer (PHY) Specifications; Amendment 2: Enhancements for extremely high throughput (EHT)," IEEE P802.11be™/D7.0 (August 2024)

Draft Standard for Information technology- Telecommunications and information exchange between systems Local and metropolitan area networks - Specific requirements; “Part 11: Wireless LAN Medium Access Control (MAC) and Physical Layer (PHY) Specifications; Amendment 6: Enhancements for ultra-high reliability (UHR)”, IEEE P802.11bn™/D0.1, January 2025, 240 pages

What is claimed is:

1. A first station (STA), comprising a transmitter, a receiver, a processor, and memory, configured to:
transmit a first physical layer protocol data unit (PPDU) to a second STA, wherein the first PPDU is defined for use with a first transmission range and the first PPDU comprises a first frame;
transmit a second PPDU to the second STA, wherein the second PPDU is defined for use with a second transmission range and the second transmission range extends beyond the first transmission range, the second PPDU comprising a second frame and at least one of the first frame or the second frame comprising, respectively, first and second information for soliciting a response from the second STA;
receive a third PPDU from the second STA, wherein the third PPDU is defined for use with the first transmission range and comprises a third frame; and
transmit data to the second STA based on the third PPDU comprising third information in the third frame indicating an availability to receive data.

2. The first STA of claim 1, configured to:
receive a fourth PPDU from the second STA, wherein the fourth PPDU is defined for use with the second transmission range, the fourth PPDU comprising a fourth frame; and
transmit data to the second STA based on the third and fourth PPDUs, wherein either the third information in the third frame or fourth information in the fourth frame indicates availability to receive the data.

3. The first STA of claims claim 1 and claim 2, wherein each of the first and third PPDUs comprise a non-high throughput (non-HT) PPDU; and wherein each of the second and fourth PPDUs comprise one of an enhanced long range (ELR) PPDU or a distributed resource unit (DRU) PPDU.

4. The first STA of claim 1 - 3, wherein the first and second frames comprise first and second initial control fames (ICFs), respectively; and wherein the third and fourth frames comprise first and second initial control reply (ICR) frames, respectively.

5. The first STA of claim 4, wherein the first ICF and the second ICF are different.

6. The first STA of any of claims claim 1 - 5, wherein the first frame comprises a clear to send (CTS)-To-Self or a modified CTS-To-Self frame.

7. The first STA of any of claims claim 4 - 6, wherein the first ICF and the second ICF comprise a multi-user (MU)-ready to send (RTS) frame, a ready to send (RTS) frame, or a buffer status report (BSRP) frame; or the first and second frames include a modified version of a multi-user (MU)-ready to send (RTS) frame, a ready to send (RTS) frame, or a buffer status report (BSRP) frame.

8. The first STA of any of claims claim 1 - 7, wherein the first frame includes an indication of dual transmission where the second frame is to be transmitted after the first frame, and wherein the first frame or the second frame includes an indication requesting dual transmission from the second and the third STAs.

9. The first STA of any of claims claim 1 - 8, wherein the second frame is transmitted at least one interframe space (SIFS) time after the first frame is transmitted.

10. The first STA of any of claims claim 4 - 9, wherein the first ICR and the second ICR comprise a multi-STA block acknowledge (BA) frame, a modified multi-STA BA frame, or a CTS frame or a modified CTS frame.

11. The first STA of any of claims claim 1 - 10, wherein the third frame comprises an indication of dual transmission where the fourth frame is to be transmitted after the third frame.

12. The first STA of any of claims claim 1 - 11, wherein the first STA or the second STA are further configured to disable the dual transmission.

13. The first STA of any of claims claim 1 - 12, wherein at least the first STA comprises an access point (AP).

14. The first STA of any of claims claim 1 - 13, wherein the second STA comprises a plurality of STAs or comprises functionality of a plurality of STAs.

15. A method, implemented by a first station (STA), the method comprising:
transmitting a first physical layer protocol data unit (PPDU) to a second STA, wherein the first PPDU is defined for use with a first transmission range and the first PPDU comprises a first frame;
transmitting a second PPDU to the second STA, wherein the second PPDU is defined for use with a second transmission range and the second transmission range extends beyond the first transmission range, the second PPDU comprising a second frame and at least one of the first frame or the second frame comprising, respectively, first and second information for soliciting a response from the second STA;
receiving a third PPDU from the second STA, wherein the third PPDU is defined for use with the first transmission range and comprises a third frame; and
transmitting data to the second STA based on the third PPDU comprising third information in the third frame indicating availability to receive the data.

16. The method of claim 15, further comprising:
receiving a fourth PPDU from the second STA, wherein the fourth PPDU is defined for use with the second transmission range, the fourth PPDU comprising a fourth frame; and
transmitting data to the second STA based on the third and fourth PPDUs, wherein either the third information in the third frame or fourth information in the fourth frame indicates availability to receive data.

17. The method of claims claim 15 and claim 16, wherein first and third PPDUs comprise a non-high throughput (non-HT) PPDU; and the second and fourth PPDUs comprise an enhanced long range (ELR) PPDU or a distributed resource unit (DRU) PPDU.

18. The method of any of claim 15 - 17, wherein the first and second frames comprise first and second initial control fames (ICFs), respectively; and the third and fourth frames comprise first and second initial control reply (ICR) frames, respectively.

19. The method of any of claims claim 18, wherein the first ICF and the second ICF are different.

20. The method of any of claims claim 15 - 19, wherein the first frame comprises a clear to send (CTS)-To-Self or a modified CTS-To-Self frame.

21. The method of any of claims claim 18 - 20, wherein the first ICF and the second ICF comprise a multi-user (MU)-ready to send (RTS) frame, a ready to send (RTS) frame, or a buffer status report (BSRP) frame; or the first and second frames include a modified version of a multi-user (MU)-ready to send (RTS) frame, a ready to send (RTS) frame, or a buffer status report (BSRP) frame.

22. The method of any of claims claim 15 - 21, wherein the first frame includes an indication of dual transmission where the second frame is to be transmitted after the first frame, and the first frame or the second frame includes an indication requesting dual transmission from the second and the third STAs.

23. The method of any of claims claim 15 - 22, wherein the second frame is transmitted at least one interframe space (SIFS) time after the first frame is transmitted.

24. The method of any of claims claim 18 - 23, wherein the first ICR and the second ICR comprise a multi-STA block acknowledge (BA) frame, a modified multi-STA BA frame, or a CTS frame or a modified CTS frame.

25. The method of any of claims claim 15 - 24, wherein the third frames comprise an indication of dual transmission where the fourth frame is to be transmitted after the third frame.

26. The method of any of claims claim 14 - 25, wherein the first STA or the second STA are further configured to disable the dual transmission.

27. The method of any of claims claim 14 - 26, wherein at least the first STA comprises an access point (AP).

28. The method of any of claims claim 14 - 27, wherein the second STA comprises a plurality of STAs or comprises functionality of a plurality of STAs.

29. A first station (STA), comprising a transmitter, a receiver, a processor, and memory, configured to:
transmit a first physical layer protocol data unit (PPDU) to a second STA, wherein the first PPDU is defined for use with a first transmission range and the first PPDU comprises a first frame;
transmit a second PPDU to the second STA, wherein the second PPDU is defined for use with a second transmission range and the second transmission range extends beyond the first transmission range, the second PPDU comprising a second frame and at least one of the first frame or the second frame comprising, respectively, first and second information for soliciting a response from the second STA;
receive a third PPDU from the second STA, wherein the third PPDU is defined for use with the first transmission range and comprises a third frame;
receive a fourth PPDU from the second STA, wherein the fourth PPDU is defined for use with the second transmission range, the fourth PPDU comprising a fourth frame; and
transmit data to the second STA based on the third and fourth PPDUs, wherein either the third information in the third frame or fourth information in the fourth frame indicates availability to receive the data.

30. A method, implemented by a first station (STA), the method comprising:
transmitting a first physical layer protocol data unit (PPDU) to a second STA, wherein the first PPDU is defined for use with a first transmission range and the first PPDU comprises a first frame;
transmitting a second PPDU to the second STA, wherein the second PPDU is defined for use with a second transmission range and the second transmission range extends beyond the first transmission range, the second PPDU comprising a second frame and at least one of the first frame or the second frame comprising, respectively, first and second information for soliciting a response from the second STA;
receiving a third PPDU from the second STA, wherein the third PPDU is defined for use with the first transmission range and comprises a third frame;
receiving a fourth PPDU from the second STA, wherein the fourth PPDU is defined for use with the second transmission range, the fourth PPDU comprising a fourth frame; and
transmitting data to the second STA based on the third and fourth PPDUs, wherein either the third information in the third frame or fourth information in the fourth frame indicates availability to receive the data.

31. A first station (STA), comprising a transmitter, a receiver, a processor, and memory, configured to:
transmit a first physical layer protocol data unit (PPDU) to a second STA, wherein the first PPDU is defined for use with a first transmission range, wherein the first PPDU comprises a first frame;
transmit a second PPDU to the second STA, wherein the second PPDU is defined for use with a second transmission range, wherein the second transmission range extends beyond the first transmission range, the second PPDU comprising a second frame, wherein at least one of the first frame or the second frame comprises, respectively, first and second information to solicit a second response from the second STA; and
prevent transmission of data to the second STA based on a failure to receive a third PPDU from the second STA in response to the first PPDU, or failure to receive a fourth PTO from the second STA in response to the second PPDU.

32. A method, implemented by a first station (STA), the method comprising:
transmitting a first physical layer protocol data unit (PPDU) to a second STA, wherein the first PPDU is defined for use with a first transmission range, wherein the first PPDU comprises a first frame;
transmitting a second PPDU to the second STA, wherein the second PPDU is defined for use with a second transmission range, wherein the second transmission range extends beyond the first transmission range, the second PPDU comprising a second frame, wherein at least one of the first frame or the second frame comprises, respectively, first and second information to solicit a second response from the second STA; and
preventing transmission of data to the second STA based on a failure to receive a third PPDU from the second STA in response to the first PPDU, or failure to receive a fourth PTO from the second STA in response to the second PPDU.
